(19) United States
(12) Patent Application Publication
(10) Pub. No.: US 2015/0078984 A1
(43) Pub. Date: Mar. 19, 2015

(54) METHOD FOR CONTROLLING THE TEMPERATURE IN THE COMBUSTION FURNACE OF A CLAUS UNIT

(71) Applicant: THYSSENKRUPP UHDE GMBH, Dortmund (DE)

(72) Inventor: Holger Thielert, Dortmund (DE)

(73) Assignee: THYSSENKRUPP INDUSTRIAL SOLUTIONS AG, Essen (DE)

(21) Appl. No.: 14/394,031

(22) PCT Filed: Mar. 27, 2013
(86) PCT No.: PCT/EP2013/000912

§ 371 Date: Oct. 10, 2014

(30) Foreign Application Priority Data
Apr. 12, 2012 (DE) 102012007161.2

(51) Int. Cl. C01B 17/04

(52) U.S. Cl. CPC C01B 17/0447; C01B 17/0417
USPC 423/574.1

(57) ABSTRACT

The invention relates to a method for reducing the nitrogen content in the oxygenous oxidation gas of a Claus plant, by which control of the temperature in the combustion furnace of a Claus plant can be achieved, by combusting a sulphurous acid gas in a Claus combustion furnace so that a sulphur dioxide-containing product gas is obtained, from which a part-stream is branched off, which, as determined by a measured value, is recycled to the oxygenous oxidation gas so to avoid an undesired temperature increase in the combustion furnace, when, occasionally, an acid gas which is very rich in sulphur is fed to the combustion furnace of a Claus plant, and to at the same time achieve a reduction of the nitrogen content in the Claus tail gas.

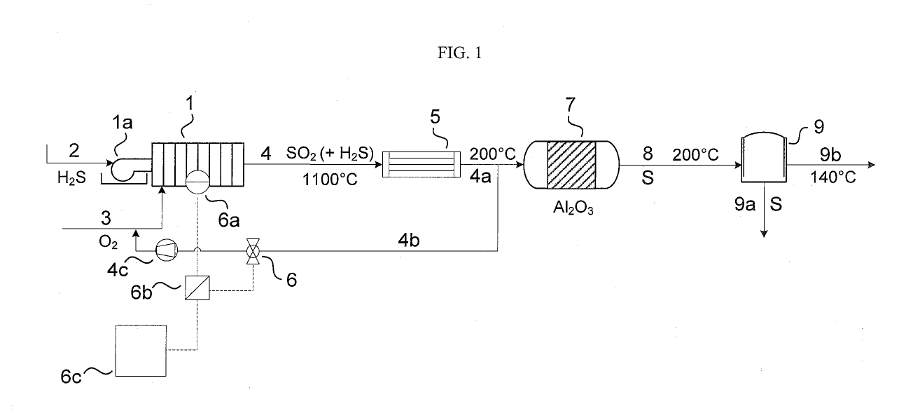

The invention relates to a method for controlling the temperature in the combustion furnace of a Claus plant, according to which control of the temperature in the combustion furnace of a Claus plant can be achieved, with a sulphurous acid gas being combusted in a Claus combustion furnace so that a sulphur dioxide-containing product gas is obtained, from which a part-stream is branched off, which, as determined by a measured value, is recycled to the oxygenous oxidation gas or to the Claus combustion furnace so to avoid an undesired temperature increase in the combustion furnace, when, occasionally, an acid gas which is very rich in sulphur is fed to the combustion furnace, and at the same time achieve a reduction of the nitrogen content in the Claus tail gas.

Many technical processes yield a sulphurous acid gas which cannot be used for further applications or cannot be used without reservations if the sulphurous compounds have not been removed. Examples of processes of such kind are refinery processes, coke-oven gas production processes, natural gas cleaning processes or blast-furnace cleaning processes. The sulphurous acid gas contained in the gases to be processed is normally removed by a gas scrubber so that a gas cleaned from sulphur compounds is obtained which can be used in further applications. The sulphurous acid gases thus obtained can mostly not be used for further applications and are converted to elemental sulphur in a Claus plant. The elemental sulphur may then be sold or taken to a final disposal site without further treatment.

The conversion of sulphurous acid gases in the Claus plant is carried out by the so-called Claus process which was developed in the 19th century to allow downstream processing of the large amounts of hydrogen sulphide obtained. In this process, part of the hydrogen sulphide (H₂S) is combusted to sulphur dioxide (SO₂) in a first reaction stage, and the sulphur dioxide thus obtained is then converted with the residual hydrogen sulphide in the presence of a catalyst in a subsequent reaction stage to give elemental sulphur (S) and water (H₂O). Many sulphurous acid gases also contain a certain degree of sulphur-organic compounds instead of hydrogen sulphide, these compounds allowing further processing if they are passed into the combustion furnace, where they are also combusted to give sulphur dioxide with carbon dioxide and water as additional product gases, so that the subsequent reaction with hydrogen sulphide can be carried out in the same way. The sulphur compounds passed into the combustion furnace and the content of combustible compounds in the acid gas may be reasons for a varying calorific value of the sulphurous gas which has been fed into the combustion furnace. Upon completion of the Claus process and removal of all sulphurous gases a so-called Claus tail gas is obtained, which may still contain tail gas of a calorific value, and may therefore have a significantly high calorific value. This tail gas may be used for various further applications, as, for example, for heating purposes or for metallurgical purposes.

The combustion furnace must have a certain temperature to ensure adequate reactivity of the acid gas with the sulphurous compounds. For this reason, frequently oxygenated air is supplied as oxidation gas. However, this is not desirable for reasons of cost, as in such case oxygen enrichment is to be carried out in an air fractionation unit. If, on the other hand, an oxygenated oxidation gas is used, the calorific value of the sulphurous acid gas supplied must not be too high to avoid overheating of the combustion furnace.

Some embodiments therefore use an oxygenated oxidation gas for an extended period of time or permanently and compensate the increase in temperature by adding an inert gas. The latter may be water vapour, for example. This allows adequate control of the temperature in the combustion furnace. The addition of water vapour, however, incurs additional cost, as water is to be heated first to produce the water vapour so that it is to be considered to replace the water vapour by a gas that is less expensive.

It would therefore be advantageous to feed a low-cost inert gas to the combustion furnace of a Claus process, with an inert gas serving to dilute the oxygenous oxidation gas, which is used in a combustion furnace for the oxidation of the sulphurous acid gas. There are embodiments according to prior art which recycle the cleaned and cooled product gas back to the Claus plant and to the Claus combustion furnace.

CA1139531A1 describes a process for the conversion of sulphur dioxide in a combustion gas from an industrial process at low temperature which yields elemental sulphur, in which process the desulphurised, cleaned and cooled product gas (Claus plant tail gas) is continuously passed through a heat exchanger and heated, the latter being in turn indirectly heated by the combustion gas, the product gas then being fed to a combustion furnace, where this desulphurised product gas reacts with further sulphurous acid gas and an oxygenous oxidation gas to give a sulphur dioxide-containing combustion gas, which is then desulphurised, cleaned and cooled in subsequent steps so that a desulphurised, cleaned and cooled product gas is obtained.

WO0130692A2 describes a process for the production of elemental sulphur from a hydrogen sulphide-containing acid gas based on a Claus process, where part of the acid gas is burnt to sulphur dioxide in a combustion furnace, and the combustion gas obtained which contains sulphur dioxide is freed from sulphur dioxide in a purification zone, and another part-stream of the hydrogen sulphide-containing acid gas reacts with sulphur dioxide in a catalyst zone to form elemental sulphur, with part of the cleaned product gas being recycled to the catalyst zone in metered amounts, so that the temperature in the catalyst zone can be controlled by the amount of recycled product gas and the desulphurised product stream is recycled to the combustion furnace.

None of the before-mentioned documents describe the control of the combustion furnace temperature by the recycling of inert sulphur dioxide-containing Claus combustion gas. It would, however, be of advantage if the temperature in the Claus combustion furnace could be controlled by the supplied Claus combustion gas, as it is a low-cost and inert gas and can thus be recycled to the Claus process.

Control of the temperature by a supplied inert gas can suitably be implemented by the sulphur dioxide-containing combustion gas obtained from the combustion in the Claus combustion furnace, as it does not disturb the actual combustion process in the Claus combustion furnace owing to the high content of sulphur dioxide and water, therefore behaves inert and can therefore be fed without further treatment to the oxygenous oxidation gas of a Claus combustion furnace, so that it is not necessary to furnish heat energy in order to heat the inert control gas.

The objective is therefore to provide a method by which a part-stream of the combustion gas from the combustion furnace of a Claus plant, where a sulphurous acid gas is burnt with an oxygenous oxidation gas to yield sulphur dioxide, is separated from the sulphur dioxide-containing combustion gas produced and mixed with the oxygenous gas fed to the combustion furnace, the mixing being done so as to ensure that combustion can be maintained without any problem and overheating of the combustion furnace resulting from a temporarily high calorific value of the acid gas feed is avoided.

The invention achieves this objective by a method according to which a part-stream of a sulphur dioxide-containing combustion gas is separated downstream of the combustion furnace of a Claus plant and, depending on a measured value which serves to judge the combustion behaviour of the combustion furnace, recycled and added to the oxygenous oxidation gas. In an advantageous embodiment, the measured value represents the temperature in the Claus combustion furnace, as this measured value bears relation to the temperature in the combustion furnace and may at the same time serve to control the temperature of the oxidation gas feed. It is also possible to introduce the recycled flow of inert combustion gas for temperature control directly into the combustion furnace but, for metering reasons, this is not the preferred embodiment.

The method provides for feeding a sulphur dioxide-containing gas to the oxidation gas upstream of the combustion furnace so that the total volume fraction of the fed oxidation gas will also reduce the nitrogen content in the oxidation gas. This is of advantage when an oxygenated oxidation gas is fed at the same time so that the nitrogen content of the combustion gas can be decreased partly or, in case pure oxygen is used as oxidation gas, completely. At the same time the combustion in the Claus furnace is still controllable.

In most embodiments, the tail gas of a Claus plant is recycled to the industrial gas which has been freed from sulphur compounds in a gas scrubber. By recycling the tail gas to the gas freed from sulphur compounds in the gas scrubber, the nitrogen content in this gas increases if atmospheric air is used for heating the Claus combustion furnaces. For many applications this is not desirable. An example in this connection is the direct reduction of iron (DRI process) where the use of a nitrogenous gas will disturb the production process. By employing an oxygenated oxidation gas or by employing pure oxygen as oxidation gas it is possible to avoid an increased nitrogen content in the gas scrubber-treated gas containing the admixed Claus tail gas.

Particular claim is laid to a method for reducing the nitrogen content in the oxygen-providing oxidation gas of a Claus plant, comprising the following reaction steps:
provision of a sulphurous acid gas which is fed to the combustion furnace of a Claus plant,
provision of an oxygenous oxidation gas which is also fed to the combustion furnace of a Claus plant,
combustion of the sulphurous acid gas by means of the oxygenous oxidation gas in the combustion furnace, yielding a sulphur dioxide-containing combustion gas which is discharged from the combustion furnace of the Claus plant,
reaction of the sulphur dioxide-containing combustion gas with a hydrogen sulphide-containing acid gas in a Claus reactor of the Claus plant, yielding a sulphurous product gas from the Claus reactor which is freed from sulphur in a separation step so that a sulphur-free product gas is obtained,
   and which is characterised in that
a part-stream is separated from the sulphur dioxide-containing combustion gas or from another gas obtained thereof and recycled to the oxygenous oxidation gas or the combustion furnace for dilution, with the ratio of recycled part-stream to oxygenous oxidation gas being determined by at least one measured value so that
it is possible to control the temperature in the combustion furnace.

The introduction of a part-stream of the sulphur dioxide-containing combustion gas into the Claus combustion furnace allows precise control of the combustion in the Claus combustion furnace and hence the temperature inside the combustion furnace by the metered amount of part-stream even if the calorific value of the sulphurous acid gas is submitted to variations.

After completion of the second reaction stage, i.e. the actual Claus reaction, the Claus reactor yields a sulphurous product gas which is freed from elemental sulphur in an appropriate separation step. This could be a condensation step, for example. The sulphur content may thus be decreased to a low level. The person skilled in the art will understand a “sulphur-free” product gas to be free of sulphur under normal technical conditions and having a certain residual content depending on the processing method. In most of these processing methods the maximum residual content is 1.0 percent by volume. The method embodying the invention may also comprise post-treatment steps for complete desulphurisation. An example in this connection is given by U.S. Pat. No. 4,085,199A.

In one embodiment of the invention the measured value which is used for controlling the amount of the separated part-stream recycled to the oxidation gas refers to the temperature measured in the Claus combustion furnace. During normal operation the temperature in the furnace ranges between 1050° C. and 1150° C. The constituent amount of part-stream supplied from the Claus combustion furnace may, for example, be controlled via deviations from this temperature value. The temperature, however, may also be measured between the outlet of the combustion furnace and the inlet of the part-stream into the oxidation gas and used as a measured value. It represents a measure for the temperature in the combustion furnace and, in combination with a measured value for the temperature of the oxidation gas upstream of the part-stream inlet, may be used for controlling the temperature in the combustion furnace. The measured value may also be a temperature value measured upstream of the point where the part-stream is separated from the combustion gas. The measured value may also refer to fractional measurements of gas constituents, including, for example, nitrogen, water vapour, carbon dioxide, sulphur dioxide or oxygen. They may be measured at any point but preferably in the part-stream which has previously been separated. Hence it is possible, for example, to use a constituent amount of 21 percent by volume oxygen in the oxidation gas feed with admixed part-stream from the Claus combustion furnace as measured value for controlling the process stream mentioned. The arbitrary measured value may be taken individually or in plurality, using this plurality of measured values in combination or as comparative values for controlling the constituent amount.

The part-stream may, in principle, be separated at any point of the Claus process downstream of the combustion furnace. In one embodiment of the invention the part-stream is separated directly from the sulphur dioxide-containing combustion gas which is discharged from the combustion furnace of the Claus plant. If an oxygenated gas or pure oxygen is used as oxidation gas, it is normally required to cool the part-stream in order to prevent the temperature in the combustion furnace from rising to an undesired level. This can be achieved by the standard process steps in accordance with the state of the art, as, for example, by an air cooler.

Subsequent to a cooling process, the Claus reaction of the sulphur dioxide with the hydrogen sulphide continuing downstream of the separation of the part-stream takes place at a significantly lower temperature which in most embodiments ranges between 100 and 250° C. The method embodying the invention may also be carried out by separating a part-stream at this point so that the part-stream is separated from the low-sulphur product gas which is obtained from the second reaction stage of the Claus reactor. The person skilled in the art is also familiar with a configuration of the Claus reaction in several stages. According to this invention the part-stream may also be separated between these stages. Last but not least it is also possible to separate a part-stream from the cooled Claus tail gas, the part-stream being sulphur-free and being fed as part-stream to the oxidation gas.

The method embodying the invention may also include cooling, heating, condensation or separation steps at any point of the process flow. To carry out the method embodying the invention, the part-stream can, in principle, be separated at any point of the process flow. Preferably it is, however, separated at a point, however, at which the temperature of the part-stream is still high enough to achieve the advantages of the invention. It is also possible to separate several or any number of part-streams, and to do so at any point, and to recycle them depending on a measured value to the oxygenous oxidation gas of the Claus combustion furnace.

In another embodiment, the oxygenous oxidation gas used is oxygenated air or pure oxygen. In a further embodiment, a hydrocarbonaceous fuel gas is supplied to the combustion furnace of the Claus plant. The gases mentioned can be fed to the combustion furnace in controlled amounts so that the combustion in the Claus combustion furnace can be controlled by the feed of these gases.

At the end of the whole Claus process, the sulphur-free Claus tail gas produced still has a residual calorific value depending on the industrial gas used. If coke oven gas is used as industrial gas for desulphurisation, the desulphurised gas still has a residual content of coke oven gas. This may be used for heating, for example. In an advantageous embodiment of the method embodying the invention the sulphur-free Claus tail gas produced is used for heating a coke oven. As it is virtually free of sulphur, the use of the product gas as fuel gas is environmentally-friendly. The Claus tail gas obtained may also be recycled to the gas which has been freed from sulphur compounds in the gas scrubber. The Claus tail gas may be used for any further application desired. It may also undergo post-treatment to further clean the gas from sulphur compounds.

In a further embodiment of the invention the sulphur-free and coke oven gas-containing product gas or sulphur-free industrial gas produced is used in the production of direct-reduced iron (DRI process). An example of a process for the production of direct-reduced iron is described in DE2246885A1. This process requires the product gas to be free of nitrogen and sulphur to avoid quality losses of the iron obtained from direct reduction. This can be ensured if the method embodying the invention is carried out with the appropriate process parameters. It is of advantage to use a nitrogen-free oxidation gas so that the product gas is free of nitrogen. In the case of a high fraction of recycled part-stream, it is also possible, however, to use a nitrogenous oxidation gas.

It is also possible to use the industrial gas which has been freed from sulphur compounds in the gas scrubber for the production of direct-reduced iron. If the Claus tail gas is recycled to this gas, its nitrogen content will be reduced if an oxygenated oxidation gas or pure oxygen is used as oxidation gas for the Claus combustion furnace as a result of the dilution with the nitrogen-free Claus tail gas. It is therefore well-suited for the production of direct-reduced iron.

In an embodiment of the method embodying the invention the constituent amount of the part-stream in the oxidation gas of the Claus combustion furnace is controlled according to the invention in such a way that the nitrogen fraction in the industrial gas which has been cleaned in the gas scrubber amounts to 2 to 6 percent by volume after addition of the Claus tail gas. The nitrogen fraction in the industrial gas cleaned in the gas scrubber normally amounts to 6 to 10 percent by volume if no part-stream has been added.

Further claim is laid to the use of the industrial gases mentioned. Claim is laid to the use of the Claus tail gas produced according to the method embodying the invention and to the gas containing the recycled Claus tail gas and freed from sulphur compounds in the gas scrubber according to the method embodying the invention. Both gases can be free of nitrogen for further applications if an oxygenated oxidation gas is used for the Claus combustion furnace. Nitrogen-free means a nitrogen content which also includes residual amounts of nitrogen from a production process. Claim is also laid to the use of the Claus tail gas obtained by the method embodying the invention in the production of direct-reduced iron.

Claim is also laid to the use of an industrial gas for the production of direct-reduced iron, the industrial gas having been freed from sulphurous acid gases in a gas scrubber, with the sulphurous acid gas having been converted into sulphur by the method embodying the invention by dilution of the cleaned industrial gas with the desulphurised tail gas from the Claus process. It may also be used as fuel gas.

The invention involves the advantage that the combustion and the temperature in the Claus furnace of a Claus plant can be controlled by adding a low-cost inert gas to the oxidation gas of a Claus combustion furnace, with a part-stream of the combustion gas being used as inert gas, the part-stream having been separated from the sulphur dioxide-containing combustion gas downstream of the Claus combustion furnace and cooled. If oxygenated air is used as oxidation gas, the sulphur-free product gas obtained can be used for the production of direct-reduced iron.

The invention is explained in more detail by means of a drawing, with the method embodying the invention not being limited to this embodiment.

A sulphurous acid gas (2) of a major content of hydrogen sulphide (H₂S) and varying fractions of sulphur-organic compounds (R₂S, R: organic remainder) is fed via a Claus burner (1a) to a Claus combustion furnace (1). Examples of sulphur-organic compounds are thiophene or mercaptans. The Claus combustion furnace (1) is also supplied with an oxygenous oxidation gas (3) so that a sulphur dioxide-containing combustion gas (4, SO₂) is generated by the combustion of the sulphur compounds (2). The combustion is carried out at sub stoichiometric conditions so that a certain residual amount of hydrogen sulphide (H₂S) remains in the combustion gas (4). In this way, subsequent addition of hydrogen sulphide is not required. The temperature of the combustion gas (4) is approximately 1100° C. The gas is cooled in a cooler (5), the combustion gas (4a) obtained being around 200° C. The invention provides for separating or branching off a part-stream (4b) and recycling it to the oxygenous oxidation gas (3). Metering of the part-stream (4b) is controlled by a valve (6), the valve being controlled by a thermocouple (6a) by way of measuring the temperature in the combustion furnace (1). For the separation of the part-stream (4b), an interposed pump (4c) is provided. Evaluation and control may be implemented by means of an evaluation device (6b) with processor (6c). The remaining flow of sulphur dioxide-containing combustion gas (4) passes through the cooler (5) into Claus reactor (7) where the excessive hydrogen sulphide reacts with the sulphur dioxide-containing combustion gas (4) in the presence of a bauxite catalyst (Al₂O₃) and produces a sulphurous product gas (8) with elemental sulphur (S). The temperature of the sulphurous product gas (8) thus obtained is approx. 200° C. The gas is further desulphurised (9a) in a condensation step so to produce a sulphur-free Claus tail gas (9b).

### List of Reference Numbers and Designations

1 Claus combustion furnace
1a Claus burner
2 Sulphurous acid gas
3 Oxygenous oxidation gas
4 Sulphur dioxide-containing combustion gas
4a Cooled combustion gas
4b Part-stream of combustion gas
4c Pump
5 Cooler
6 Valve
6a Thermocouple
6b Evaluation device
6c Processor
7 Claus reactor
8 Sulphurous product gas
9 Condensation step
9a Sulphur
9b Claus tail gas

1-8. (canceled)

9. A method for controlling the temperature in a combustion furnace of a Claus plant, comprising:
feeding a sulphurous acid gas into the combustion furnace of the Claus plant;
feeding an oxygenous oxidation gas into the combustion furnace of the Claus plant;
combusting the sulphurous acid gas by the oxygenous oxidation gas in the combustion furnace to yield a sulphur dioxide-containing combustion gas;
discharging the sulphur dioxide-containing combustion gas from the combustion furnace;
feeding at least a part of the sulphur dioxide-containing gas discharged from the combustion furnace to a Claus reactor;
reacting the sulphur dioxide-containing combustion gas with a hydrogen sulphide-containing acid gas in the Claus reactor to yield a sulphurous product gas;
separating sulphur out of the sulphurous product gas to yield a sulphur-free product gas;
recycling a partial-stream of the discharged sulphur dioxide-containing combustion gas back to at least one of the combustion furnace or a stream of oxygenous oxidation gas to be fed into said combustion furnace for dilution; and
determining a ratio of the recycled partial-stream gas to the oxygenous oxidation gas that enters the combustion furnace by at least one measured value to permit control of the combustion furnace temperature.

10. The method of claim 9, wherein the at least one measured value represents the temperature measured in the Claus combustion furnace.

11. The method of claim 9, further comprising cooling the partial-stream of the discharged sulphur dioxide-containing combustion gas.

12. The method of claim 9, further comprising recycling a partial-stream of the sulphur-free product gas back to at least one of the combustion furnace or a stream of oxygenous oxidation gas to be fed into said combustion furnace for dilution.

13. The method of claim 9, wherein at least one of oxygenated air or pure oxygen is used as the oxygenous oxidation gas.

14. The method of claim 9, further comprising supplying a hydrocarbonaceous fuel gas to the combustion furnace of the Claus plant.

15. The method of claim 9, further comprising controlling a nitrogen fraction in an industrial gas, which industrial gas has been freed from sulphurous acid gasses in a gas scrubber, by the addition of the sulphur-free product gas to the industrial gas such that the nitrogen fraction therein is between about 2 percent to about 6 percent by volume.
